(19) United States
(12) Patent Application Publication
(10) Pub. No.: US 2017/0036512 A1
(43) Pub. Date: Feb. 9, 2017

(54) System to prevent harm to children, pets or others left in unattended vehicles in hot weather

(71) Applicant: Harold James (Jim) Willard, JR., Washington, DC (US)

(72) Inventor: Harold James (Jim) Willard, JR., Washington, DC (US)

(21) Appl. No.: 14/756,123

(22) Filed: Aug. 4, 2015

(51) Int. Cl. B60H 1/00; B60R 16/033; B60H 1/26

(52) U.S. Cl. CPC B60H 1/00892; B60H 1/00828; B60H 1/00735; B60H 1/262; B60R 16/033; B60H 1/00978; B60R 2011/0045

(57) ABSTRACT

A system is presented to prevent harm to occupants of unattended vehicles in warm weather due to the greenhouse effect by circulating ambient air through the vehicle using the blower from the vehicle's air conditioning system powered by a solar cell array and rechargeable batteries, with a thermometer controller to engage and shut off the system at preset high and low temperatures, situated in a recessed area on the roof to minimize drag when the vehicle is moving and avoid detracting from the appearance of the vehicle.

### CROSS REFERENCE TO RELATED APPLICATIONS

Provisional application filed Aug. 5, 2014; Ser. No. 61/999,736

### STATEMENT OF FEDERALLY SPONSORED RESEARCH OR DEVELOPMENT

not applicable

### NAMES OF THE PARTIES TO JOINT RESEARCH AGREEMENT

not applicable

### REFERENCE TO A “SEQUENCE LISTING” ETC.

not applicable

### BACKGROUND OF THE INVENTION

Children, pets and others are far too often left in unattended vehicles in weather which may not seem to be dangerous. However, the temperature in a closed automobile, or one in which the windows are left slightly open, may reach in excess of 125° F. in a matter of minutes due to the greenhouse effect, even though the ambient temperature may be only in the 80's. Such conditions can be frightening for a child and prove to be injurious or even deadly. Recently a mother was charged with homicide when her toddler died after being left for only a brief time while she was shopping.

Individuals who must remain with their vehicles under similar conditions will often run their engines in order to operate the air conditioners in their vehicles without draining the vehicle's battery. However, this uses fuel, polluting the atmosphere, and could be dangerous if the vehicle's ventilation system is faulty. The purpose of the present invention is to provide a system to circulate ambient air through the vehicle using the vehicle's blower in its air conditioning system, but powered by solar cell and rechargeable battery arrays. A digital thermometer provides the interior temperature to verify that safe conditions are being maintained to occupants and passersby.

### REVIEW OF PRIOR ART

There are over one thousand patents referring to solar power applications, including cell phones, energy systems, vehicles, aircraft, etc. However, none appear to encompass the scope and purpose of the present invention. A brief description of representative patents follows: Louch et al (U.S. Pat. No. 8,947,039B2; 2015) provides an electronic system for optimizing power generated by solar cells for vehicles whose engines are powered by solar energy. Such a system would add unjustified complexity to the present system, probably increasing maintenance and repair costs, as well as down-time, causing inconvenience and expense to the owner; Adkins (U.S. Pat. No. 5,131,888; 1992) provides a solar powered exhaust fan for use on portable buildings, such as outhouses, and is not appropriate for vehicle use; Freeman (U.S. Pat. No. 8,886,379B2; 2014) presents an expandable solar cell array for use on commercial vehicles which offers considerable drag when the vehicle is in motion and is unattractive for consumer vehicles; Gali (U.S. Pat. No. 5,276,393; 1994) presents radio frequency electronic circuitry for optimizing recharging solar powered battery systems, which is unnecessarily complicated for the present application; Ferng (U.S. Pat. No. 5,588,909; 1996) presents a solar power-operated cooling system for motor vehicles which requires installing blowers in the doors of the vehicle and uses a small solar cell array which could prove ineffective in shady areas or inclement weather; Clenet (U.S. Pat. No. 5,081,912; 1992) presents a vent on the roof for exhausting air from a vehicle occupant compartment which prevents water that enters the vent from entering the occupant area, which is prevented in the present invention through the use of a gasket around the cell-battery cavity and the absence of vents exposed to the elements; Chan and Mujamoto (U.S. Pat. No. 8,993,366B2; 2015) provide high efficiency, lightweight, flexible solar power sheets which may prove useful to the present invention since solar cell arrays which conform to the shape of the vehicle's roof are desirable to minimize disrupting the appearance of the vehicle, however this invention does not encompass the scope of the present invention; Upadhyaya (U.S. Pat. No. 8,993,172B2; 2015) presents a Li-ion battery and components on metal wire, which does not encompass the scope of the present invention, but might replace the battery unit presently presented; Farmont (U.S. Pat. No. 4,800,803; 1989) presents a ventilation device for a vehicle roof window placed in a window opening having a light-permeable cover, which includes a solar powered fan; a primary application of this invention is to motor homes, campers etc. It appears to operate without a rechargeable battery, unlike the present invention, and would be less attractive for family vehicles than the present invention.

### BRIEF SUMMARY OF THE INVENTION

This invention provides a system by which ambient air is forced through a vehicle whose motor is not running using the existing blower of the vehicle's air conditioning system. The a/c system is slightly modified to allow the blower to be powered by a solar cell and rechargeable battery array situated on the vehicle's roof. The rechargeable battery provides power when the sun's rays are temporarily blocked and is recharged by the solar cell array. The solar cell and battery arrays are located in a recessed area in the vehicle's roof to minimize drag and avoid detracting from the vehicle's appearance. A gasket seals the arrays within the recessed area. A switch on the dashboard allows the driver to select the solar ventilator system or the air conditioner, or a neutral position when neither is needed. A digital thermometer on the dash alerts the occupants as to the temperature inside the vehicle. A temperature sensitive switch turns the blower on at a predetermined upper value and off at a lower value. The system is designed to be simple and easy to maintain by using the blower already existing for the air conditioner. It is expected that this system would be most effective when installed during manufacture of the vehicle. This invention is intended specifically to mitigate the dangerous conditions existing with the greenhouse effect, when drivers may feel that little danger exists, but, in fact, very serious, even lethal conditions may prevail even for moderate weather conditions. Vents in the recessed cavity in the roof allow air from the cabin to circulate through the solar cell and battery arrays for cooling.

### BRIEF DESCRIPTION OF THE DRAWINGS

FIG. 1. Sketch of a vehicle showing the location of the solar cell and rechargeable battery arrays recessed into the vehicle's roof.

FIG. 2. Expanded view of the solar cell and rechargeable battery arrays of FIG. 1 revealing the configuration of the arrays, gasket to seal the arrays from moisture and dust within the recessed area, electrical connections, and slots to allow cooling of the arrays.

FIG. 3. Electrical circuitry for the system: solar cell-battery arrays located on the vehicle's roof; switches, thermometer controller and indicator light located on the vehicle's dash, and modification to the vehicle's air conditioner system to facilitate using the blower of the air conditioner to circulate air through the vehicle, powered by the solar cell and battery arrays.

### DETAILED DESCRIPTION OF THE INVENTION

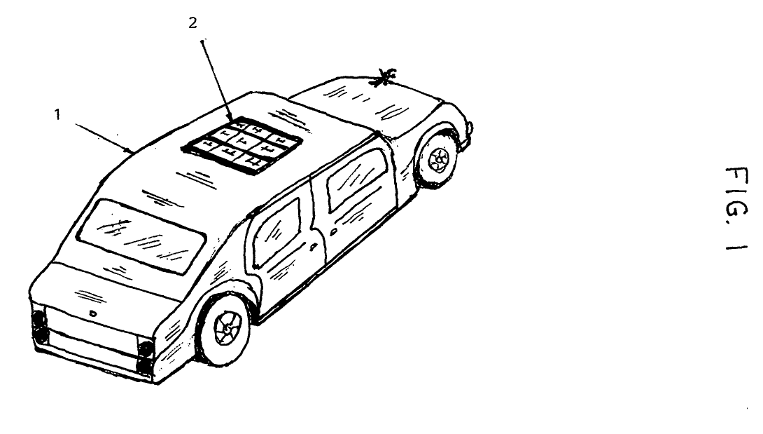

FIG. 1 is a sketch of an automobile (1) showing the location of the solar-battery array (2) on the roof. The battery unit is beneath the solar array and is not visible in this view. The assembly is situated in a recessed area of sufficient depth to have the surface of the assembly be flush with the surface of the roof in order to minimize drag when the vehicle is moving and to minimize adverse impact on the appearance of the vehicle.

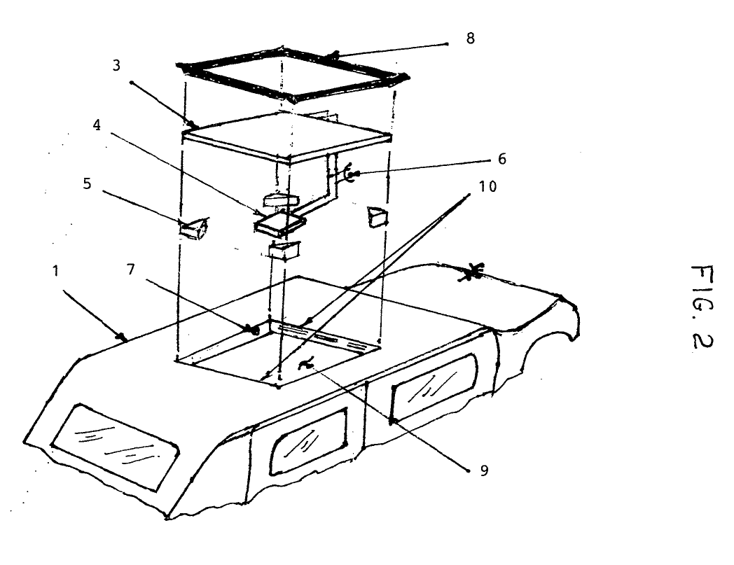

FIG. 2 is an expanded view of the components. The solar cell panel (3) is positioned above the smaller battery pact (4). Corner supports (5) separate the solar cell array from the battery pact, which is securely fixed to the floor of the cavity. The two units are connected electrically and alug plug (6) connects the assembly to the vehicle's electrical system through receptacle (7). A gasket (8) seals the assembly from moisture and dirt. The recessed area (9) includes vents (10) at the front and rear to allow air flow from the occupants' area to be circulated between the solar cell and battery units for cooling.

The color of the solar cell array may be selected to complement the color of the vehicle. The units are fixed securely through brackets affixed to vehicle's roof (not shown).

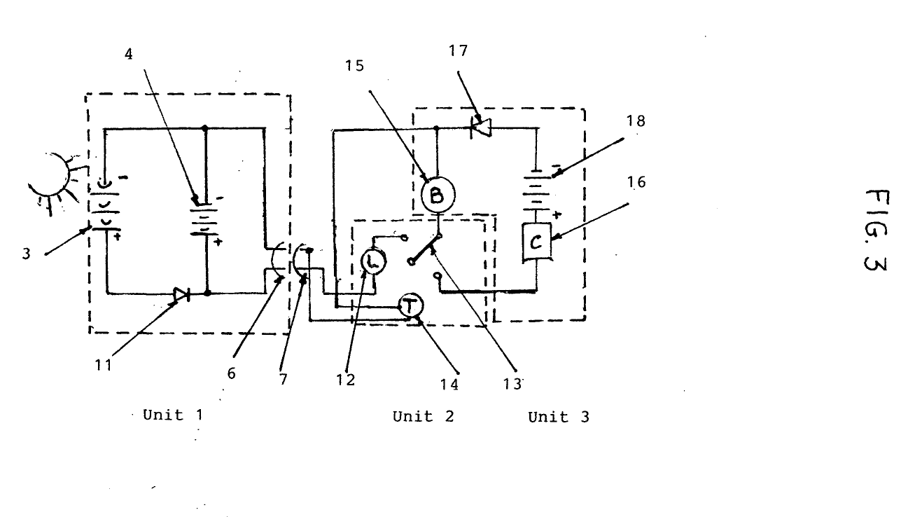

The electrical circuit, FIG. 3, has three major units. Unit 1 is located on the roof. It includes the solar cell array (3), the rechargeable, battery (4), and a diode (11) to prevent the battery from discharging through the solar array, while allowing the solar array to charge the battery. The battery provides power when insufficient solar energy is available from the sun due to clouds, shade, dust or other cause. An electrical plug suitable for low voltage outdoor use (6) engages the receptable (7) in the wall of the recessed area.

Unit 2 is located on the dashboard of the vehicle. Light (12) indicates that the system is energized, after selection by switch (13), which may connect contact “S” (solar), N (neutral), or A (air conditioning). A digital thermometer controller (14), in view on the dash, alerts occupants and passersby as to the status of the system (on/off) and the temperature inside the vehicle, and also turns the system on when the temperature inside the vehicle reaches a predetermined high value and turns it off at a low value. The thermometer controller operates only when the solar system is selected by switch 15. This controller is not in the air conditioning circuit. “B” is the blower (15) of the air conditioner “C” (16), which is not operable when the solar system is in operation. Diode (17) blocks current from the vehicle's battery (18) from entering the solar circuit while the blower is being used for the solar system.

I claim:

1) A system to prevent harm to occupants of unattended vehicles in warm weather due to the greenhouse effect by circulating ambient air through the vehicle using the blower of the vehicle's air conditioning system powered by a solar cell and rechargeable battery array situated on the roof;

2) That the system of claim 1 is recessed into the roof of the vehicle to minimize drag and not detract from the appearance of the vehicle;

3) That the system of claims 1 and 2 further includes lights to indicate the status of the system and a thermometer controller to engage and shut off the system at high and low temperatures and display the temperature inside the vehicle to alert occupants and passersby as to the conditions within the vehicle.
